(19) United States
(12) Patent Application Publication
(10) Pub. No.: US 2005/0130014 A1
(43) Pub. Date: Jun. 16, 2005

(54) Bipolar plate of fuel cell and fabrication method thereof

(76) Inventors: Myung-Seok Park, Jinhae, Gyeongsangnam-Do (KR); Hong Choi, Changwon, Gyeongsangnam-Do (KR); Kyu-Jung Kim, Seongnam Gyeonggi-Do (KR); Myeong-Ho Lee, Busan (KR); Cheol-Hwan Kim, Gimhae, Gyeongsangnam-Do (KR); Yong-Jun Hwang, Changwon, Gyeongsangnam-Do (KR); Seung-Tae Ko, Daegu (KR); Sam-Chul Ha, Changwon, Gyeongsangnam-Do (KR); Sam-Chul Ha, Changwon Gyeongsangnam-Do (KR); Tae-Hee Cho, Changwon Gyeongsangnam-Do (KR)

Correspondence Address: FLESHNER & KIM, LLP, P.O. BOX 221200, CHANTILLY, VA, 20153, US

(21) Appl. No.: 10/484,614

(22) PCT Filed: Dec. 12, 2003
(86) PCT No.: PCT/KR03/02730

(51) Int. Cl. H01M 8/02; H01M 2/08

(52) U.S. Cl. 429/35; 429/38; 429/39; 264/138; 264/219

(57) ABSTRACT

In a bipolar plate of a fuel cell and a fabrication method thereof, the bipolar plate of the fuel cell includes a plate; a fluid flowing space formed on both sides of the plate; a fluid guide mesh installed on the fluid flowing space; an inflow path formed on the plate to be connected with the fluid flowing space; and an outflow path formed on the plate to be connected with the fluid flowing space. Also, in the fabrication method, the bipolar plate is fabricated with a certain mold and by a processing method. Accordingly, it is possible to uniformize flux distribution and reduce flow resistance of fuel and air respectively flowing into a fuel electrode and an air electrode of a fuel cell. In addition, reaction area with a M.E.A and diffusion zone can be increased, and fabrication can be simplified and facilitated.

### TECHNICAL FIELD

The present invention relates to a fuel cell, and in particular to a bipolar plate of a fuel cell and a fabrication method thereof capable of unuiformizing flux distribution, reducing flow resistance of fuel and air respectively flowing into a fuel electrode and an air electrode of a fuel cell and simplifying fabrication thereof.

### BACKGROUND ART

A fuel cell is generally environment-friendly energy, and it has been developed in order to substitute for the conventional fossil energy. As depicted in FIG. 1, the fuel cell includes a stack 100 to be combined with at least one unit cell 101 in which electrochemical reaction occurs; a fuel supply pipe 200 connected to the stack 100 so as to supply fuel; an air supply pipe 300 connected to the stack 100 so as to supply air; and discharge pipes 400, 500 for discharging by-products of fuel and air passing the reaction respectively. The unit cell 101 includes a fuel electrode (anode) (not shown) in which fuel flows; and an air electrode (cathode) (not shown) in which air flows.

The operation of the fuel cell will be described.

First, fuel and air are supplied to the fuel electrode and the air electrode of the stack 100 through the fuel supply pipe 200 and the air supply pipe 300 respectively. Fuel supplied to the fuel electrode is ionized into positive ions and electrons (e−) through electrochemical oxidation reaction in the fuel electrode, the ionized positive ions are moved to the air electrode through an electrolyte, and the electrons are moved to the fuel electrode. The positive ions moved to the air electrode perform electrochemical reduction reaction with air supplied to the air electrode and generate by-products such as reaction heat and water, etc. In the process, by the movement of the electrons, electric energy is generated. The fuel through the reaction in the fuel electrode, and water and additional by-products generated in the air electrode are respectively discharged through the discharge pipes 400, 500.

The fuel cell can be classified into various types according to electrolyte and fuel, etc. used therein.

In the meantime, as depicted in FIG. 2, the unit cell 101 constructing the stack 100 includes two bipolar plates 10 having an open channel 11 in which air or fuel flows; and a M.E.A (membrane electrode assembly) 20 arranged between the two bipolar plates 10 so as to have a certain thickness and area. The two bipolar plates 10 and the M.E.A 20 arranged therebetween are combined with each other by additional combining means 30, 31. A channel formed by a channel 11 of the bipolar plate 10 and a side of the M.E.A 20 constructs a fuel electrode, and oxidation reaction occurs while fuel flows through the channel of the fuel electrode. And, a channel formed by a channel 11 of the other bipolar plate 10 and the other side of the M.E.A 20 constructs an air electrode, and reduction reaction occurs while air flows through the channel of the air electrode.

A shape of the bipolar plate 10, in particular, a shape of the channel 11 affects contact resistance generated in flowing of fuel and air and flux distribution, etc., and contact resistance and flux distribution affect power efficiency. And, the bipolar plates 10 have a certain shape appropriate to processing facilitation and mass production.

As depicted in FIG. 3, in the conventional bipolar plate, through holes 13, 14, 15, 16 are respectively formed at each edge of the plate 12 having a certain thickness and a rectangular shape.

And, plural channels 11 are formed on a side of the plate 12 so as to connect the through hole 13 with the diagonally arranged through hole 16. The channels 11 have a zigzag shape. As depicted in FIG. 4, in the section of the channel 11, the channel 11 has a certain width and depth and an open side. Plural channels 11 are formed on the other side of the plate 12 so as to connect the diagonally arranged two through holes 14, 16, and the channels 11 have the same shape with the channels formed on the opposite side.

The operation of the conventional bipolar plate will be described. First, fuel and air respectively flow into the through holes 13, 14, fuel and air passing the through holes 13, 14 flow into the channels 11. Fuel or air in the channels 11 flows zigzag along the channels 11 and is discharged to the outside through the through holes 15, 16. In that process, oxidation reaction occurs in the M.E.A 20 (shown in FIG. 2) in which fuel flows, simultaneously reduction reaction occurs in the M.E.A in which air flows.

However, in the conventional bipolar plate, because the channels 11 are formed as zigzag, flux can be distributed evenly to some degree. However, because the channels in which fuel and air flow are complicate and long, flow resistance is increased, and pressure loss for making fuel and air flow is increased. In addition, because processing is complicate and intricate in fabrication, a production cost is high.

### TECHNICAL GIST OF THE PRESENT INVENTION

In order to solve the above-described problems, it is an object of the present invention to provide a bipolar plate of a fuel cell and a fabrication method thereof capable of uniformizing flux distribution, reducing flow resistance of fuel and air respectively flowing into a fuel electrode and an air electrode of a fuel cell and simplifying fabrication thereof.

In order to achieve the above-mentioned objects, a bipolar plate of a fuel cell includes a plate having a certain thickness and area; a fluid flowing space formed on both sides of the plate so as to have a certain width, length and depth; a fluid guide mesh installed on the fluid flowing space so as to have a certain shape; an inflow channel formed on the plate so as to be connected with the fluid flowing space and receive a fluid; and an outflow channel formed on the plate so as to be connected with the fluid flowing space and discharge the fluid.

In addition, a method for fabricating a bipolar plate of a fuel cell includes fabricating a mold for processing a plate on which a fluid flowing space having a certain area and depth is formed at both sides and an internal channel is formed by a support mesh projected as a mesh shape from the fluid flowing space; forming a plate with the mold; processing an inflow channel on the plate so as to make a fluid flow into the fluid flowing space having the support mesh; and processing an outflow channel on the plate so as to make the flow in the fluid flowing space flow out.

In addition, a bipolar plate of a fuel cell includes a plate having a certain thickness and area; a channel region having latticed protrusions by plural latticed grooves formed along a certain area of both sides of the plate; an inflow channel formed at a side of the plate so as to be connected with the latticed grooves in the channel region and receive a fluid; and an outflow channel formed at a side of the plate so as to discharge the fluid passing the latticed grooves of the channel region.

In addition, a method for fabricating a bipolar plate of a fuel cell includes fabricating a plate having a certain thickness and area; performing mechanical processing for forming latticed grooves by latticed protrusions formed on both sides of the plate; and processing an inflow channel and an outflow channel on the plate so as to be connected with the latticed grooves.

In addition, a bipolar plate of a fuel cell includes a plate having a certain thickness and area in which plural channels consisting of plural ups and downs are formed at both sides on the middle by being pressed so as to have a certain width and length; and a sealing member respectively adhered to the outline of the both sides of the plate so as to form internal channels with the channels of the plate, an inflow channel and an outflow channel in which a fluid flows in/out through the channels.

In addition, a method for fabricating a bipolar plate of a fuel cell includes cutting a plate so as to have a certain size; press-processing both sides of the cut plate so as to form plural channels in which a fluid flows; and combining a sealing member with the outline of the press-processed plate.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates the conventional fuel cell system;

FIG. 2 is an exploded-perspective view illustrating part of a stack of the conventional fuel cell;

FIG. 3 is a plane view illustrating a bipolar plate of the conventional fuel cell;

FIG. 4 is a sectional view taken along a line A-B in FIG. 3;

FIG. 5 is a plane view illustrating a first embodiment of a bipolar plate of a fuel cell in accordance with the present invention;

FIG. 6 is an exploded-perspective view illustrating part of the bipolar plate of the fuel cell in accordance with the first embodiment of the present invention;

FIG. 7 is a flow chart illustrating a first embodiment of a method for fabricating a bipolar plate of a fuel cell in accordance with the present invention;

FIG. 8 is an exploded-perspective view illustrating a stack of the bipolar plate of the fuel cell in accordance with the first embodiment of the present invention;

FIG. 9 is a plane view illustrating an operational state of the bipolar plate of the fuel cell in accordance with the first embodiment of the present invention;

FIGS. 10 and 11 are a plane view and a front sectional view illustrating a second embodiment of a bipolar plate of a fuel cell in accordance with the present invention;

FIG. 12 is a flow chart illustrating a second embodiment of a method for fabricating a bipolar plate of a fuel cell in accordance with the present invention;

FIG. 13 is a plane view illustrating an operational state of the bipolar plate of the fuel cell in accordance with the second embodiment of the present invention;

FIGS. 14 and 15 are a plane view and a sectional view illustrating a third embodiment of a bipolar plate of a fuel cell in accordance with the present invention; and

FIG. 16 is a flow chart illustrating a third embodiment of a method for fabricating a bipolar plate of a fuel cell in accordance with the present invention.

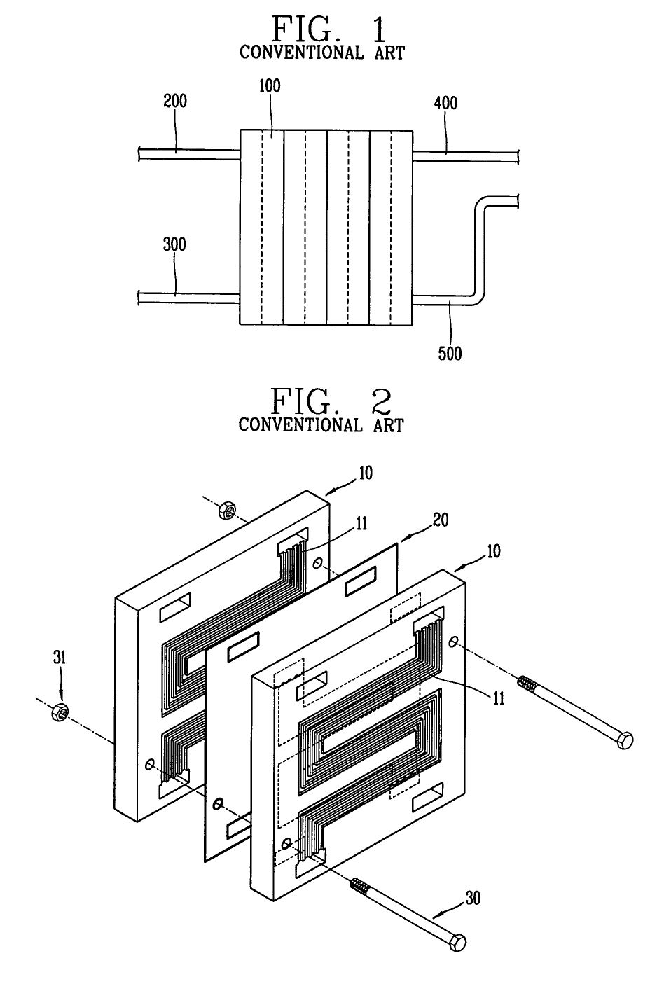

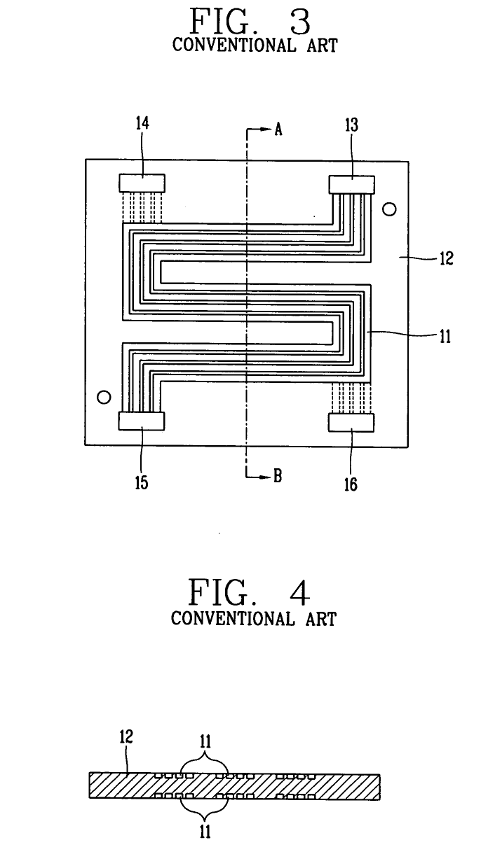

### DETAILED DESCRIPTION OF THE INVENTION

Hereinafter, the preferred embodiments of the present invention will be described with reference to accompanying drawings.

First, a first embodiment of a bipolar plate of a fuel cell in accordance with the present invention will be described.

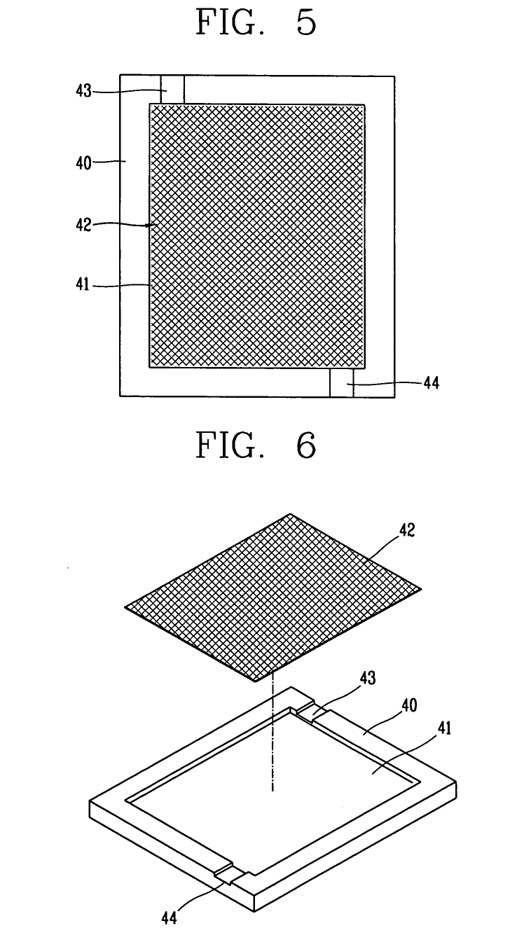

FIG. 5 is a plane view illustrating a first embodiment of a bipolar plate of a fuel cell in accordance with the present invention, and FIG. 6 is an exploded-perspective view illustrating part of the bipolar plate of the fuel cell in accordance with the first embodiment of the present invention.

As depicted in FIGS. 5 and 6, the first embodiment of the bipolar plate of the fuel cell in accordance with the present invention includes a plate 40 having a certain thickness and area; a fluid flowing space 41 formed on both sides of the plate 40 so as to have a certain width, length and depth; a fluid guide mesh 42 installed in the fluid flowing space 41 so as to have a certain shape; an inflow path 43 formed on the plate 40 to be connected to the fluid flowing space 41 for introducing a fluid; and an outflow path 44 formed on the plate 40 to be connected to the fluid flowing space 41 for discharging the fluid.

The plate 40 has a rectangular shape and has a certain thickness, the fluid flowing space 41 is respectively formed on both sides of the rectangular plate 40, and it has a rectangular shape and has a certain depth. The plate 40 is made of a stainless steel material. The plate 40 and the fluid flowing space 41 can have other shapes besides the rectangular shape.

The fluid guide mesh 42 has a rectangular shape smaller than the fluid flowing space 41 so as to be inserted into the fluid flowing space 41 of the plate 40, and it has a thickness not greater than the depth of the fluid flowing space 41.

The inflow path 43 is constructed as at least one through hole and is formed at a side of the plate 40. The outflow path 43 is constructed as at least one through hole and is formed at the opposite side of the inflow path 43 so as to be diagonal to the inflow path 43.

Next, a first embodiment of a method for fabricating a bipolar plate of a fuel cell in accordance with the present invention will be described.

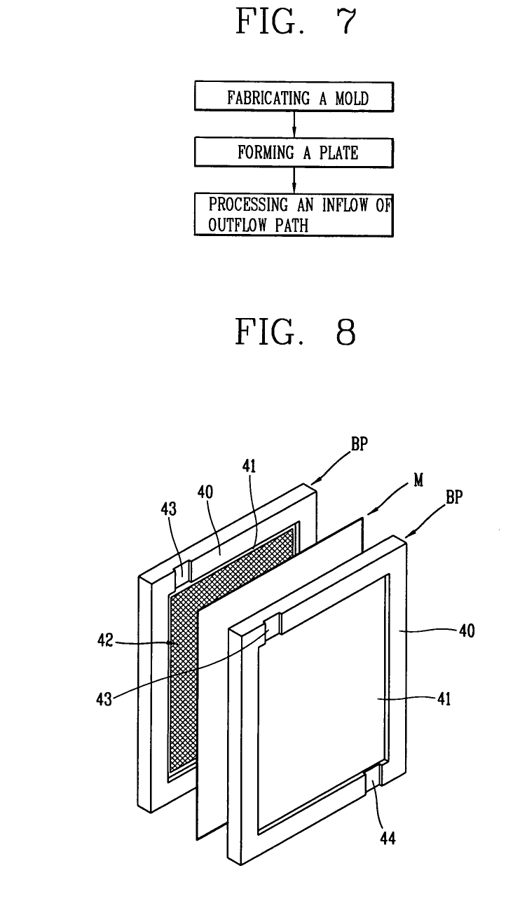

FIG. 7 is a flow chart illustrating a first embodiment of a method for fabricating a bipolar plate of a fuel cell in accordance with the present invention.

As depicted in FIG. 7, in the first embodiment of the method for fabricating the bipolar plate of the fuel cell in accordance with the present invention, a mold for processing a plate on which a fluid flowing space having a certain area and depth is formed at both sides and a mesh is formed to be projected in the fluid flowing space is fabricated. And, a plate is processed with the mold. Herein, in the plate, a rectangular fluid flowing space having a certain depth is formed at both sides of the rectangular plate having a certain depth, and a mesh shape is formed in the fluid flowing space so as to form a channel. The mesh can be formed as various shapes.

Next, an inflow path is processed on the plate so as to make a fluid flow into the fluid flowing space having the mesh, and an outflow path is processed so as to make the fluid in the fluid flowing space flow out. The inflow path and the outflow path are respectively processed as at least one through hole or open groove.

Hereinafter, the operation of the bipolar plate of the fuel cell and the fabrication method thereof in accordance with the first embodiment of the present invention will be described.

First, the bipolar plates of the fuel cell construct a stack. In more detail, as depicted in FIG. 8, a M.E.A (M) is arranged between the bipolar plates (BP), and they are combined with each other by combining means (not shown). Herein, by the fluid flowing space 41 formed on the side of the bipolar plate (BP), the fluid guide mesh 42 formed in the fluid flowing space 41 and a side of the M.E.A (M), a path in which fuel flows is formed. By the other side of the M.E.A (M), the fluid flowing space 41 formed on a side of the other bipolar plate (BP) facing the bipolar plate (BP) and the fluid guide mesh 42 formed in the fluid flowing space 41, a path in which air flows is formed.

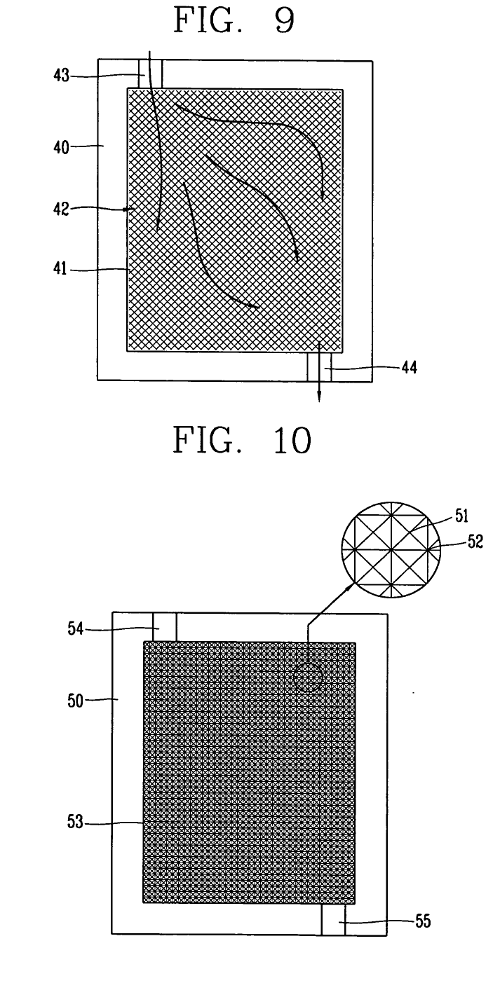

In that structure, when fuel flows into the inflow path 43 of the bipolar plate (BP), as depicted in FIG. 9, the fuel in the inflow path 43 flows into the fluid flowing space 41. And, the fuel in the fluid flowing space 41 spreads all over the fluid flowing space 41 by the fluid guide mesh 42 positioned in the fluid flowing space 41, and the fuel is discharged to the outside through the outflow path 44.

In that process, the fluid guide mesh 42 in the fluid flowing space 41 performs not only a guide function by spreading the fuel in the fluid flowing space 41 evenly but also a diffusion function by adjusting flux appropriately. Herein, distribution and pressure can be adjusted by a mesh size of the fluid guide mesh 42. In the meantime, by forming the fluid guide mesh 42 as a mesh, contact area with the M.E.A (M) contacted to the bipolar plate (BP) is comparatively reduced, and accordingly effective area of the fuel and the M.E.A (M) is increased.

In addition, air flows by passing the above-described process.

In the method for fabricating the bipolar plate of the fuel cell in accordance with the first embodiment of the present invention, by fabricating a plate with a mold, it can be mass-produced easily. In more detail, by fabricating a plate having a support mesh and processing an inflow path and an outflow path, a bipolar plate can be simply and easily fabricated.

Next, a bipolar plate of a fuel cell in accordance with a second embodiment of the present invention will be described.

FIGS. 10 and 11 are a plane view and a front sectional view illustrating a second embodiment of a bipolar plate of a fuel cell in accordance with the present invention.

As depicted in FIGS. 10 and 11, the bipolar plate of the fuel cell in accordance with the second embodiment of the present invention includes a plate 50 having a certain thickness and area; a channel region 53 having latticed protrusions 52 by plural latticed grooves 51 formed along a certain area of both sides of the plate 50; an inflow path 54 formed at a side of the plate 50 so as to be connected to the latticed grooves 51 of the channel region 53 for introducing a fluid; and an outflow path 55 formed at a side of the plate 50 so as to discharge the fluid passing the latticed grooves 51 of the channel region 53.

The plate 50 has a rectangular shape and has a certain thickness. The channel region 53 is respectively formed at both sides of the plate 50 so as to have a rectangular shape. The plate 50 and the channel region 53 can be formed as various shapes besides the rectangular shape.

The latticed protrusions 52 are formed as a rectangular cone shape, and each latticed groove 51 is formed between the latticed protrusions 52 having the rectangular cone shape. The latticed protrusion 52 can be formed so as to have a triangular cone shape.

The latticed protrusions 52 are regularly arranged. In modification, the latticed protrusions 52 can be irregularly arranged.

The inflow path 54 and the outflow path 55 are respectively formed at a side of the plate 50 as an open shape having a certain width and depth. In addition, the inflow path 54 and the outflow path 55 can be respectively formed as at least one through hole.

The bipolar plate of the fuel cell in accordance with the second embodiment of the present invention is made of a stainless steel material.

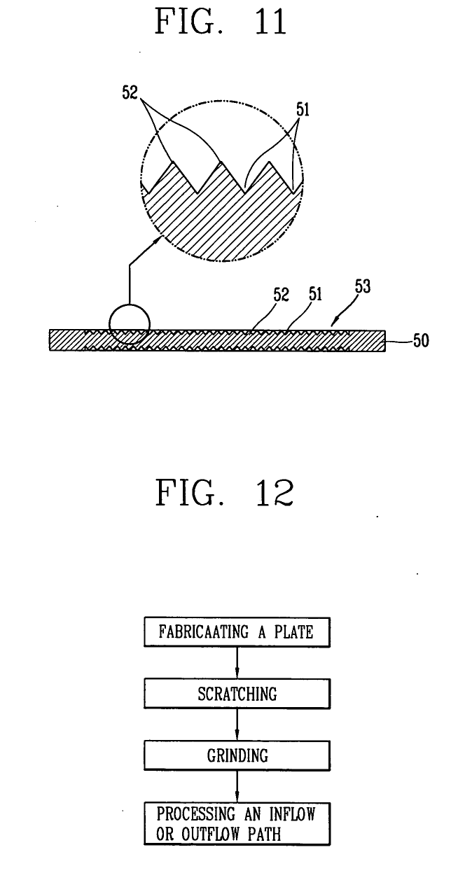

FIG. 12 is a flow chart illustrating a second embodiment of a method for fabricating a bipolar plate of a fuel cell in accordance with the present invention.

As depicted in FIG. 12, in the method for fabricating bipolar plate of the fuel cell in accordance with the second embodiment of the present invention, a first step is for fabricating a plate having a certain thickness and area. And, a second step as a mechanical processing for forming latticed grooves by latticed protrusions on both sides of the plate is performed. The second step includes the sub-steps of scratching both sides of the plate to form latticed protrusions; and grinding the scratched both sides of the plate. The latticed protrusions formed by the scratching have a rectangular-cone shape, and they can be formed as other shapes besides the rectangular-cone shape. By the scratching, latticed grooves are formed among the latticed protrusions, and the latticed grooves form channels in which fluid flows. By performing the grinding, it is possible to remove burr occurred by the scratching and process the sharp end of the latticed protrusions so as to be dull.

And, a third step is for processing an inflow path and an outflow path on the plate so as to be connected to the latticed grooves.

Hereinafter, the operation of the bipolar plate of the fuel cell and the fabrication method thereof in accordance with the second embodiment of the present invention will be described.

The bipolar plates of the fuel cell construct a stack. Herein, by the channel region 53 formed at a side of the bipolar plate (BP) and a side of the M.E.A (M), a path in which fuel flows is formed. By the other side of the M.E.A (M) and a side of the other bipolar plate (BP) facing the bipolar plate (BP), a path in which air flows is formed.

In that structure, when fuel flows into the inflow path 54 of the bipolar plate (BP), as depicted in FIG. 13, fuel in the inflow path 54 flows all over the channel region 53 through the path formed by the latticed grooves 51 in the channel region 53, and the fuel is discharged to the outside through the outflow path 55.

In the process, by a small and uniform shape like the mesh formed by the latticed grooves 51 formed by the latticed protrusions 52 in the channel region 53, the fluid can be not only spread out evenly but also diffused. Herein, by the latticed protrusions 52 formed in the channel region 53, contact area of the bipolar plate (BP) and the M.E.A (M) is relatively reduced, and effective contact area of the fuel and the M.E.A (M) is increased.

In addition, air flows through the above-described process.

In the method for fabricating the bipolar plate of the fuel cell in accordance with the second embodiment of the present invention, by processing an inflow path and an outflow path mechanically at both sides of a rectangular plate having a certain thickness with a roller, etc., fabrication is simple and easy.

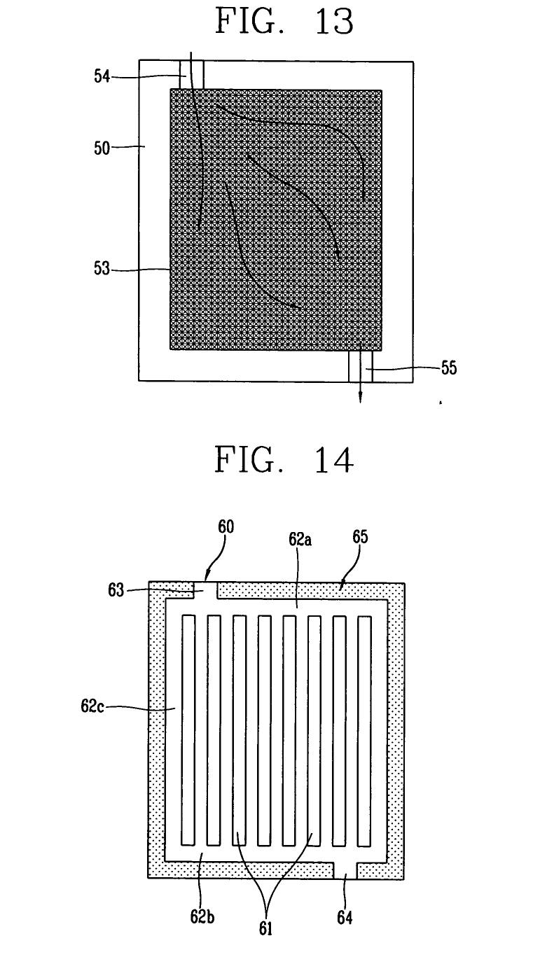

FIGS. 14 and 15 are a plane view and a sectional view respectively illustrating a third embodiment of a bipolar plate of a fuel cell in accordance with the present invention.

As depicted in FIGS. 14 and 15, the bipolar plate of the fuel cell in accordance with the third embodiment of the present invention includes a plate 60 having a certain thickness and area in which plural channels 61 consisting of plural ups and downs are formed at both sides on the middle by being pressed so as to have a certain width and length; and a sealing member 65 respectively adhered to the outline of the both sides of the plate 60 so as to form channels 62a, 62b, 62c with the channels 61 of the plate 60, an inflow channel 63 and an outflow channel 64 in which a fluid flows in/out.

The plate 60 is constructed as a rectangular metal plate, and the channels 61 are formed in a certain internal region of the rectangular metal plate. The channels 61 consisting of plural ups and downs are formed on both sides of the plate 60 at regular intervals. By pressing the plate 60, the channels 61 are respectively formed at both sides of the plate 60, and the channels 61 have the uniform depth.

The sealing member 65 has a rectangular shape and has a certain width, it has the same thickness with a height of the ups of the channel 61 and has the same size with the plate 60. Height of the ups of the channel 61 is approximately 2.5 mm.

The inflow channel 63 in which a fluid flows is formed at a side of the sealing member 65, and the outflow channel 64 is formed so as to be opposite to the inflow channel 63.

An internal channel formed by the sealing member 65 includes an inflow buffer channel 62a for distributing a fluid to the channels 61 of the plate 60; an outflow buffer channel 62b for making the fluid passing the channels 61 of the plate 60 flow into the outflow channel 64; and a connection channel 62c for connecting the inflow buffer channel 62a and the outflow buffer channel 62b.

And, a method for fabricating a bipolar plate of a fuel cell in accordance with a third embodiment of the present invention will be described.

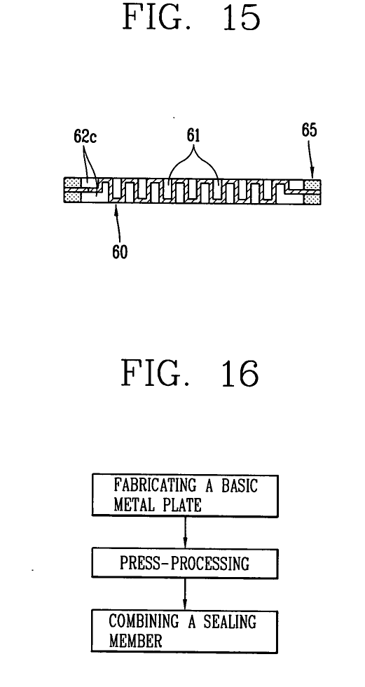

FIG. 16 is a flow chart illustrating a method for fabricating a bipolar plate of a fuel cell in accordance with a third embodiment of the present invention.

As depicted in FIG. 16, in the method for fabricating the bipolar plate of the fuel cell in accordance with the third embodiment of the present invention, a first step is for processing the plate 60 by cutting a metal plate having a certain thickness and area as a certain size, and a second steps if for press-processing the plate 60 in order to form plural channels 61 on both sides of the plate 60. The metal plate 60 has a rectangular shape.

The channels 61 of the plate 60 are fabricated as straight and have a certain length, height of ups of the channels 61 are uniform. The channel 61 of the plate 60 can have various section shape such as waveform or rectangular form.

A third step is for combining the sealing member 65 with the outline of the press-processed plate 60. The sealing member 65 is formed as a rectangular ring shape having a certain width and thickness, the sealing member 65 is combined with the outline of the plate 60 so as to encompassed the internal area of the plate 60, and accordingly the channels 62a, 62b, 62c are formed. The inflow channel 63 and the outflow channel 64 are formed on the sealing member 65. The inflow channel 63 and the outflow channel 64 can be formed by cutting part of the sealing member 65.

Hereinafter, the operation of the bipolar plate of the fuel cell in accordance with the present invention will be described.

As described-above in the first embodiment of the present invention, a stack of a fuel cell is constructed. Herein, by the ups of the straight channel 61 formed on a side of the bipolar plate (BP) and a side of the M.E.A (M), a path in which fuel flows is formed. By the other side of the M.E.A (M) and downs of the straight channels 61 formed at a side of the other bipolar plate (BP) facing the bipolar plate (BP), a path in which air flows is formed.

In that structure, when fuel flows into the inflow channel 63 of the bipolar plate (BP), the fuel in the inflow channel 63 flows through the path, namely, the inflow buffer channel 62a, the connection channel 62c, the channel 61 and the outflow buffer channel 62b. After that, the fuel is discharged to the outside through the outflow channel 64. In addition, air flows by passing the above-described process.

And, in the present invention, by fabricating a metal plate by press-processing, fabrication is simple and easy. In addition, by reducing a thickness of the bipolar plate, size and weight of the stack can be reduced.

### INDUSTRIAL APPLICABILITY

As described-above, in the bipolar plate of the fuel cell and the fabrication method thereof in accordance with the present invention, by uniformizing flux distribution of fuel and air respectively flowing into a fuel electrode and an air electrode of a fuel cell, increasing an reaction effective area with the M.E.A and increasing diffusion zone, power efficiency can be improved. By reducing flow resistance of fuel and air, pressure loss generating flow of the fuel and air, namely, pumping force can be reduced. In addition, by simplifying and facilitating fabrication, a production cost can be sharply reduced, and accordingly mass production is possible.

1. A bipolar plate of a fuel cell, comprising:
a plate having a certain thickness and area;
a fluid flowing space formed on both sides of the plate, the fluid flowing space configured to have a certain width, length and depth;
a fluid guide mesh installed in the fluid flowing space, the fluid guide mesh having a certain shape;
an inflow path formed on the plate to be connected to the fluid flowing space for introducing a fluid; and
an outflow path formed on the plate to be connected to the fluid flowing space for discharging the fluid.

2. The bipolar plate of claim 1, wherein the fluid flowing space is formed as a rectangular shape, and the fluid guide mesh has a rectangular shape not greater than a size of the fluid flowing space.

3. The bipolar plate of claim 1, wherein the fluid guide mesh has a thickness not greater than a depth of the fluid flowing space.

4. The bipolar plate of claim 1, wherein the inflow path and the outflow path are respectively constructed as at least one through hole, and they are formed at a side of the plate.

5. The bipolar plate of claim 1, wherein the inflow path and the outflow path are arranged to be diagonal to each other.

6. The bipolar plate of claim 1, wherein the plate is made of a stainless steel material.

7. A method for fabricating a bipolar plate of a fuel cell, comprising:
fabricating a mold for processing a plate on which a fluid flowing space having a certain area and depth is formed at both sides and a mesh is formed to be projected on fluid flowing space;
making a plate with the mold;
processing an inflow path on the plate for fluid flowing into the fluid flowing space having the mesh; and
processing an outflow path on the plate for fluid in the fluid flowing space flowing out.

8. A bipolar plate of a fuel cell, comprising:
a plate having a certain thickness and area;
a channel region having latticed protrusions by plural latticed grooves formed along a certain area of both sides of the plate;
an inflow path formed at a side of the plate to be connected to the latticed grooves for introducing a fluid; and
an outflow path formed at a side of the plate to be connected to the latticed grooves for discharging the fluid in the latticed grooves.

9. The bipolar plate of claim 8, wherein the latticed protrusion is formed as a rectangular-cone shape.

10. The bipolar plate of claim 8, wherein the latticed protrusions are formed regularly.

11. The bipolar plate of claim 8, wherein the inflow path and the outflow path are respectively formed at a side of the plate as an open shape having a certain width and depth.

12. The bipolar plate of claim 8, wherein the plate is made of a stainless steel material.

13. A method for fabricating a bipolar plate of a fuel cell, comprising:
fabricating a plate having a certain thickness and area;
performing mechanical processing for forming latticed grooves by latticed protrusions formed on both sides of the plate; and
processing an inflow path and an outflow path on the plate to be connected to the latticed grooves.

14. The bipolar plate of claim 13, wherein the mechanical processing step includes the sub-steps of:
scratching both sides of the plate in order to form latticed protrusions; and
grinding the scratched both sides of the plate.

15. A bipolar plate of a fuel cell, comprising:
a plate having a certain thickness and area in which plural channels consisting of plural ups and downs are formed at both sides on the middle by being pressed so as to have a certain width and length; and
a sealing member respectively adhered to the outline of the both sides of the plate so as to form internal channels with the channels of the plate, an inflow path and an outflow path in which a fluid flows in/out through the channels.

16. The bipolar plate of claim 15, wherein the internal channels includes:
an inflow buffer channel for distributing a fluid to the channels of the plate;
an outflow buffer channel for making the fluid passing the channels of the plate flow into the outflow channel; and
a connection channel for connecting the inflow buffer channel and the outflow buffer channel.

17. A method for fabricating a bipolar plate of a fuel cell, comprising:
cutting a plate so as to have a certain size;
press-processing both sides of the cut plate so as to form plural channels in which a fluid flows; and
combining a sealing member with the outline of the press-processed plate.

18. The bipolar plate of claim 17, wherein ups formed by the channels are processed so as to have uniform height in the press-processing step.

19. The bipolar plate of claim 17, wherein the channels are processed so as to be straight and have a certain length in the press-processing step.

20. The bipolar plate of claim 17, wherein the sealing member is combined with the plate so as to encompassed the internal area of the plate.
